(19) United States
(12) Patent Application Publication
(10) Pub. No.: US 2005/0154911 A1
(43) Pub. Date: Jul. 14, 2005

(54) System and method for facilitating on-premise personal introductions

(76) Inventor: Gary M. Schneider, Masonville, CO (US)

Correspondence Address: William W. Cochran;Cochran Freund & Young LLC, Suite 230, 3555 Stanford Road, Fort Collins, CO, 80525, US

(21) Appl. No.: 11/018,490

(22) Filed: Dec. 20, 2004

Related U.S. Application Data
(60) Provisional application No. 60/536,457, filed on Jan. 13, 2004.

(51) Int. Cl. H04L 9/00

(52) U.S. Cl. 713/200

(57) ABSTRACT

The present invention disclosed overcomes the disadvantages of existing introduction systems and methods by providing an on-premise personal introduction facilitation system and a method for using an on-premise personal introduction facilitation system to facilitate personal introductions in a variety of venues and applications. Various embodiments of the system allow a user to enter and search for personal/professional information relevant to a desired on-premise personal introduction. The system may be disposed at locations to facilitate timely personal introductions. The system may utilize various electronic technologies including portable message transceivers, data processing and storage systems, data acquisition and display devices to facilitate timely interactive communications. The system includes administrative controls and authentication terminals and software modules that allow an administrator to control who uses the system and the duration of use.

### CROSS REFERENCE TO RELATED APPLICATIONS

This application claims benefit of and priority to U.S. Provisional Patent Application Ser. No. 60/536,457 entitled “System And Method For Facilitating On-Premise Personal Introductions” by Gary M. Schneider, filed Jan. 13, 2004, the entire contents of which are specifically incorporated herein by reference for all it discloses and teaches.

### BACKGROUND OF THE INVENTION

a. Field of the Invention

The present invention relates to interactive data processing, and more particularly to personal introductions using interactive data processing.

b. Background of the Invention

In an effort to meet people in social, recreational or business functions people visit various venues and attend various events. One way to meet people in these situations is through personal introduction. However, given the large number of people at many venues and the limited time of an event or limitations on individuals' own available time, an individual will not usually meet more than a small percentage of the people at a nightclub, convention, conference, resort or sporting event.

Further, existing systems and methods for meeting people with common interests are focused towards only remote communications between the users. Existing systems allow users to meet on-line over a period of hours, days, or longer, after which they may have an in-person meeting at a time and location that they must determine and for which they must make arrangements.

Given a person's desire to meet someone at the venue or event in which they have common interests or attractions in a limited amount of time, a need exists for a system that overcomes the above-stated disadvantages.

### SUMMARY OF THE INVENTION

The various embodiments of the present invention overcome the disadvantages and limitations of various existing system by providing a system that allows individuals to quickly identify users with similar interests who are present at a specific location at a specific time, notify and contact users interactively, and arrange for an immediate in-person meeting.

The invention may therefore comprise an on-premise personal introduction facilitation system that includes: a data processing and storage system that stores and processes personal information from a first user and a second user; at least one client data input/output device that is electronically connected to the data processing and storage system, and that collects and displays typed personal information and photographic images from a first user and a second user, the client data input/output device located on-premise at a target location; an authentication mechanism within the data processing and storage system that validates the personal information of the first user and the second user and confirms an authorization status of the first user and the second user to access the data processing and storage system; database processing software operatively disposed in the data processing and storage system that allows the first user to query a database containing the personal information of the second user and determines information to display which facilitates an on-premise personal introduction between the first user and the second user; at least one notification device that is electronically connected to the data processing and storage system that delivers messages regarding a desired introduction from the first user to the second user, and from the second user to the first user.

The invention may further comprise a method of facilitating timely on-premise personal introductions that includes: providing an on-premise personal introduction facilitation system that includes a data processing and storage system which is electronically connected to at least one client data input/output device that captures and displays personal information and photographic images, the data processing and storage system being further electronically connected to at least one notification device; registering a first user and a second user by assigning an electronically encoded identifier; collecting and editing personal information and photographic images of a first user and a second user using the client data input/output device; storing the personal information and photographic images of the first user and the second user in a database within the data processing and storage system; authenticating credentials of the first user and the second user using the data processing and storage system; enabling the first user to search the database and display personal information and photographic images of the second user; notifying the second user, using the notification device, that the first user desires a personal introduction to the second user; displaying to the second user, through a client data input/output device, the personal information and photographic images of the first person; and notifying the first user of the second user's interest in a personal introduction.

### BRIEF DESCRIPTION OF THE DRAWINGS

FIG. 1 illustrates an on-premise introduction facilitation system.

FIG. 2 is a flow diagram illustrating the basic steps for using an on-premise introduction facilitation system.

FIG. 3 illustrates a data flow diagram.

FIG. 4 illustrates a functional flow of an on-premise introduction facilitation system.

FIG. 5 illustrates a registration screen.

FIG. 6 illustrates a first personal/professional information screen.

FIG. 7 illustrates a second personal/professional information screen.

FIG. 8 illustrates a third personal/professional information screen.

FIG. 9 illustrates a fourth personal/professional information screen.

FIG. 10 illustrates a fifth personal/professional information screen.

FIG. 11 illustrates a personal quote.

FIG. 12 illustrates a profile confirmation screen.

FIG. 13 illustrates a main menu.

FIG. 14 illustrates a search menu.

FIG. 15 illustrates a search results screen.

FIG. 16 illustrates a message entry screen.

FIG. 17 illustrates an administrative control screen.

### DETAILED DESCRIPTION OF THE INVENTION

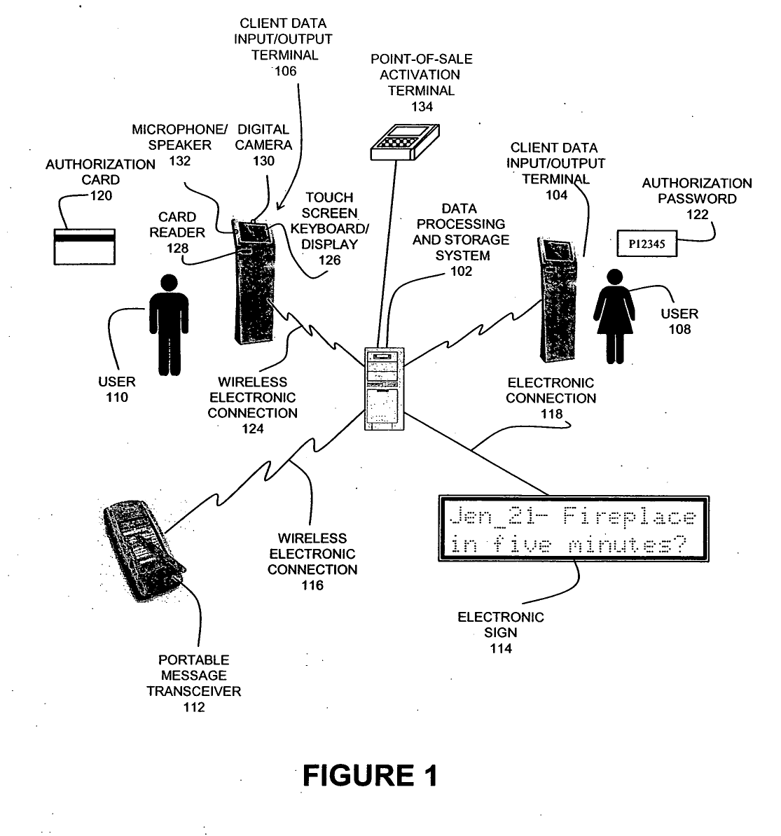

FIG. 1 illustrates an embodiment of an on-premise introduction facilitation system 100. The on-premise introduction facilitation system may comprise a data processing and storage system 102 that is electronically connected to at least one client data input/output terminal such as the client data input/output terminal 104 and 106. In one embodiment of the invention, a first client data input/output terminal 106 is a kiosk that may include a card reader 128 that is capable of reading an authorization card 120, a touch screen display 126 that permit a user to enter and view data, a photographic image capturing device such as a digital camera 130, a microphone/speaker 132, and an electronic interface to connects to the data processing and storage system 102.

In one embodiment, the data processing and storage system 102 is a server that has a Linux or Windows operating system and application software and hardware that is capable of receiving, storing, processing and transmitting data that facilitates an on-premise introduction of a first user 110 and a second user 108.

An authorization card 120 may be obtained by a first user 110. There are various ways an authorization card may be obtained. For example, in a nightclub, the authorization card 120 may be purchased from the bartender or from an automated vending machine. Alternatively, at a professional conference, the authorization card may be given to the conference participants at registration time. The authorization card 120 may be activated manually or automatically using a point-of-sale activation terminal 134. Prior to first use, the authorization card 120 may contain authorization information. The first user 110 swipes or inserts the authorization card 120 into a card reader of the client data input/output terminal. Data from the card is transmitted to the data processing and storage system 102 through an electronic wireless connection 124. The data processing and storage system 102 checks the data to verify that the user is authorized and then sends a signal back to the client input/output terminal 106 that permits the user to proceed with the registration process which is described in more detail below.

A second user 108 may use the same first client data input/output terminal 106 or a second client data input/output terminal such as the client data input/output terminal 104. The second client data input/output terminal 104 may be similar to the first client data input/output terminal 106. In some situations such as a one-time event like a cruise, it may not be necessary to store any personal or professional data entered to a card for use at a later time. If desired, an authorization password 122 that uniquely identifies the user may be used rather that an authorization card 120.

After a first user and a second user are authorized and have entered personal or professional data and data regarding interests and intent into the system, the first user 110 uses the client data input/output terminal to search for someone to meet. One embodiment of the data entry and search process is described below. The first user may select a screen name of a person he wants to meet, based on viewing information about a second user 108, and enter a short text message and/or audio message. The selection and message are transmitted to the data processing and storage system 102 which in turn may transmit the message to a notification terminal that is accessible to the user selected. The touch screen display 126 may act as a notification terminal to notify a first user 110 that a second user 108 would like to meet. However, to keep the client data input/output terminal available as much of the time as possible, alternative notification terminals such as an electronic sign 114 and portable message transceiver 112 may be used. For example, electronic sign 114 may be disposed above the bar or in any noticeable place to provide short messages. The first user 110 may use the client data input/output terminal to enter a short message that is then transmitted to the data processing and storage system 102. The data processing and storage system then transmits the message to the electronic sign 114 through the electronic connection 118. Input devices may include touch-screens, keyboards, pagers, cellular telephones, PDA or other electronic data entry device. Date input may also be performed using voice recognition software. Any of the electronic connections between the client data input/output devices may be wireless or wired as desired. Further, a second notification device 112 may a portable message transceiver such as a PDA with a wireless connection, a pager, or a cellular telephone. Notification devices such as cellular telephones provide a way for text messages or audio messages to be exchanged. Some pagers, cellular telephones and PDAs also provide a vibratory alert that may be well suited for venues that are very noisy or venues where an audible alert would be inappropriate. Upon received a vibratory alert, a user could check for a text message. In some applications, it may be desirable to provide a live attendant that demonstrates how to use the on-premise introduction facilitation system. A live attendant may invite people to try the system. A live attendant may also answer user questions. A live attendant may provide point-of-purchase services. A live attendant may assume the role of electronically introducing people to each other.

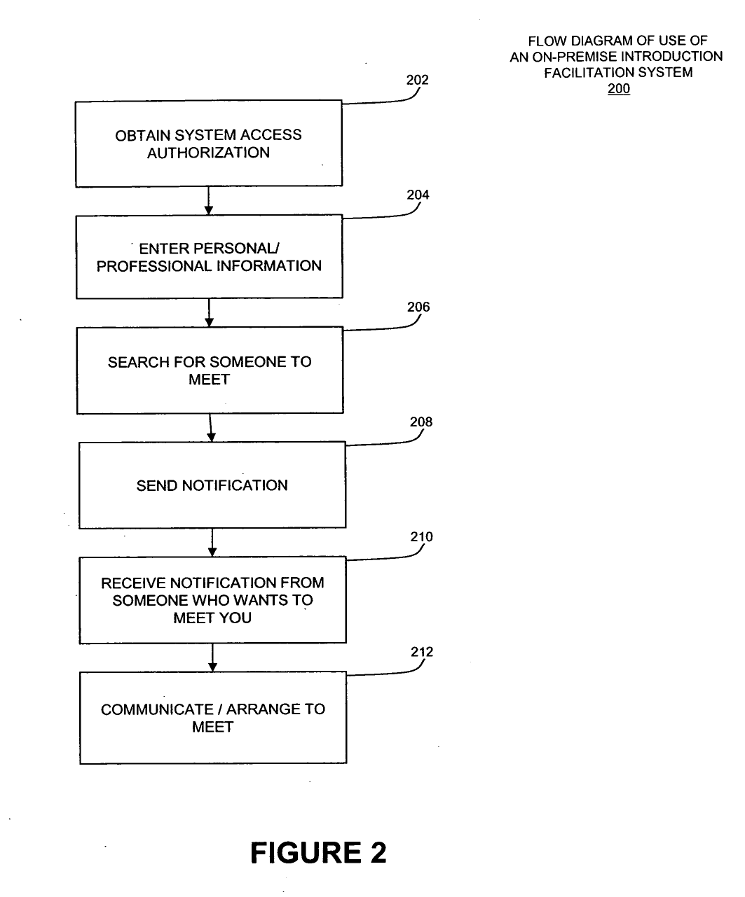

FIG. 2 is a flow diagram illustrating the basic steps for using an embodiment of an on-premise introduction facilitation system. In step 202, a user obtains system access authorization. The step of obtaining system access authorization ensures that each user is uniquely identified and verifies that user is authorized to use the system. At step 204, a user enters personal or professional information. Personal or professional information entered may include a screen name, interests, descriptive information, objective and other information as desired. At step 206, a user searches for someone to meet. The software of the data processing and storage system allows a user to select desired attributes of a person he would like to meet. For example, at a ski resort, a user who is a snowboarder may search for another snowboarder to share a lift ride or to snowboard together. At step 208, a first user, after doing step 206 search for someone to meet and finding a possible match search, sends notification to a second user that he would like to meet. At step 210, a second user receives notification from a first user that desires to meet. At step 212, after receiving notification from the first user, the second user may access a client data input/output device to send a message to the first user. The first user and second user may communicate interactively using a chat application to exchange additional information or they may arrange to meet.

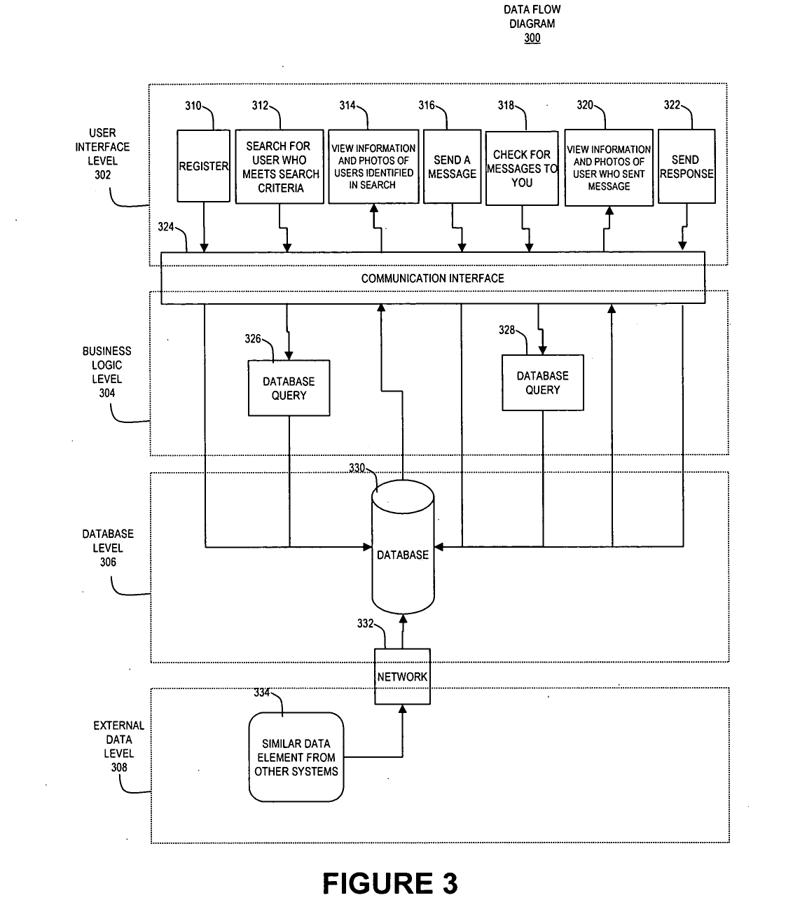

FIG. 3 illustrates a data flow diagram 300 for various functions within an embodiment of an on-premise introduction facilitation system. The user interface level 302 includes a register function 310 wherein users register to use the system. Registering to use the system may comprise for a first time user, entering personal/professional information, capturing digital photographic and audio data, obtaining authorization to use the system by providing a debit or credit card or by swiping a pre-purchased card or entering a password. Data from the register function 310 flows through a communication interface 324 to a database function 330 where the data is stored for retrieval. The communication interface 324 may be for example a local area network, a wireless network, the Internet, or any communication infrastructure desired. A search function 312 allows a first user to search for a second user to meet based on the first user's preferences and responses to questions. Preferences and responses to questions from the search function 312 flows through communication interface 324 to a database query function 326. The database query function accesses information in a database 330. The results of the database query flow from the database 330 through the communication interface 324 to a first view function 314. The first user may view information including text, audio, and photographic images relating to a second user or to any user whose data matches the search criteria. A send message function 316 allows a first user to send a message to a second user. The message may be interactive such as a chat function or it may a short text or audio message that can be transmitted to a notification device or stored for retrieval in a check message function 318. If the user is using a notification device such as a pager, a cellular telephone, an LED display, then the check message function may be manual i.e. looking at the notification device or it may be an electronically transmitted database query 328 that utilizes the communication interface 324. The check message function may allow the user to check for a message sent earlier. If a stored or interactive message exists, a second view function 320 allows a user to retrieve information that may include text, audio, and photographic information. A second user then may use a send response function 322 to send a message to first user to communicate further or to initiate an introduction. A network function 332 may be connect to the database function 330 that allows similar data elements 334 from other systems at an external data level 308 to flow to and from the database 330.

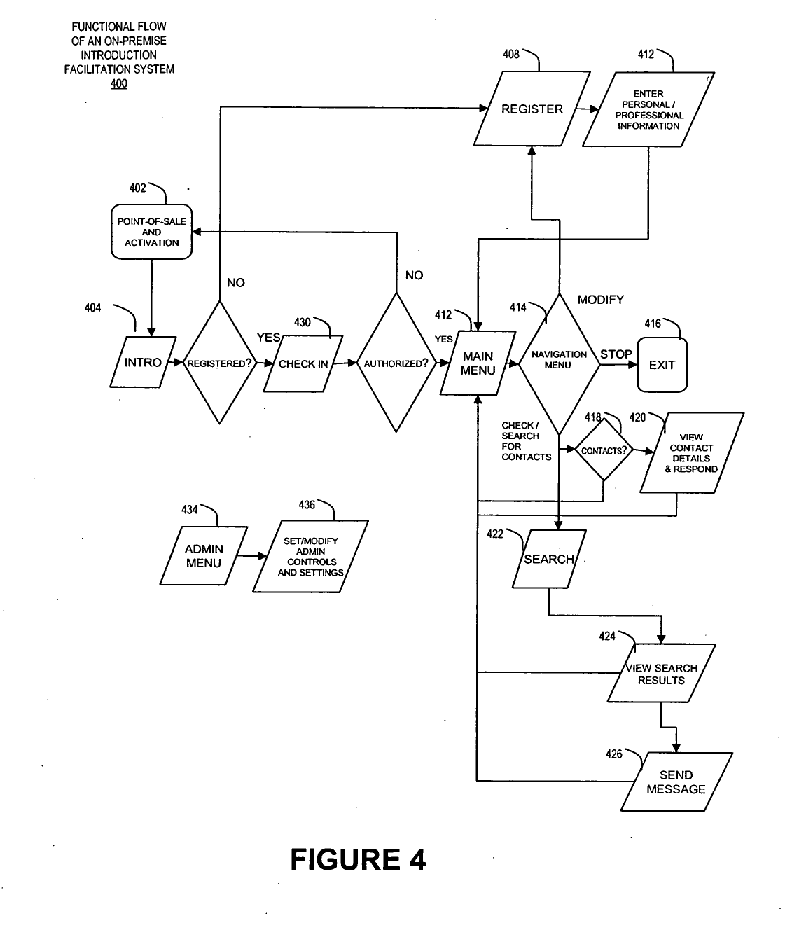

FIG. 4 illustrates one embodiment of a functional flow of an on-premise introduction facilitation system 400. In a point-of-sale and activation function 402 a user purchases a card or password or similar authorization device. An introduction screen 404 provides instructions on how to use the system. The user is then prompted to indicate if he is registered on the system. If the user is registered, he is prompted to check in 430 or log in. If the login information is invalid or the user is not authorized to use the system, the user is instructed to return to the point-of-sale and activation 402 to obtain authorization. If the registered user is authorized then he is allowed to proceed to the main menu 412. If the user is not yet registered, for example, if this is the first time the user has used the system, then he is provided with a register screen 408 that gives instructions on how to register. The user then enters personal/professional information 410 and the program proceeds to the main menu 412. From the main menu 412, the user proceeds to the navigation menu 414. The navigation menu allows the user to indicate what he wants to do next. In one embodiment, the user has the choices of exiting 416 the program, modifying 413 his personal/professional information, checking for contacts 418 in the form of messages that have been left, or searching 422 for someone. If there are contacts, i.e. messages have been left, the user may view the contact details and respond 420, after which he is returned to the main menu 412. After a search 422, the user may view the search results 424 and if desired send a message 426 after which the user is returned to the main menu 412.

An administrative menu 434 allows an administrator to set/modify administrative controls and settings 436 such as the start and stop time of a session.

More detailed examples of the content, navigational controls, appearance and data entry formats of the menu screens for one embodiment of the invention are described below. However, any desired content, controls, appearance, formats or navigation elements may be used with the system that provides information to facilitate an on-premise personal introduction. For example, any of the screens may include promotions or advertisements that are selected from a database based on information obtained from the user.

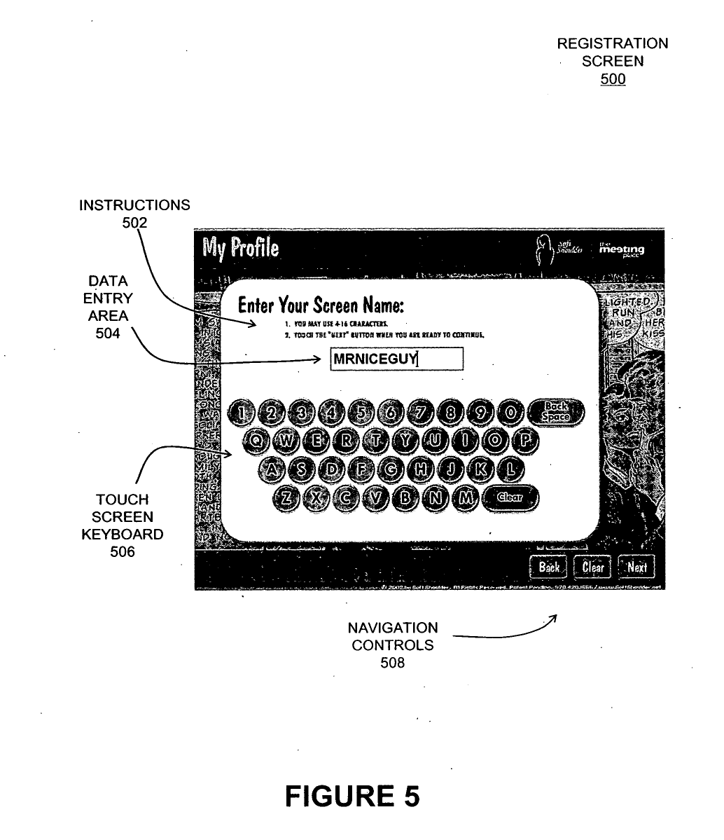

FIG. 5 illustrates a registration screen 500 for one embodiment of the invention that may include instructions 502, a data entry area 504, a touch screen keyboard 506, and navigation controls 508. The user may choose any screen name desired which may alleviate concerns the user may have about providing a real name at this point to other users. The user reads the instructions 502 and enters data into the data entry area 504 using the touch screen keyboard 506. After entering the data, the user uses the navigation controls 508 to go to the next screen or to go back to the previous screen.

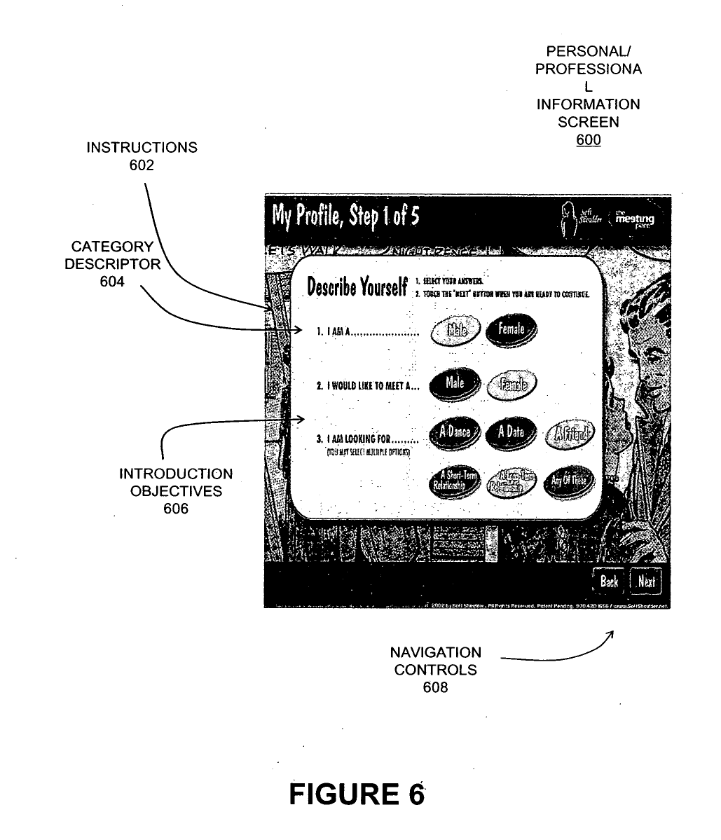

FIG. 6 illustrates a first personal/professional information screen 600. The personal/professional information screen 600 may include instructions 602, category descriptor 604, introduction objectives 606, and navigation controls 608. In the example illustrated a first user is instructed to describe, by selecting from the choices displayed, his or her gender, the gender of a second user who the first users would like to meet and the type of interaction the first user is seeking. After entering the data, the user uses the navigation controls 608 to go to the next screen or to go back to the previous screen.

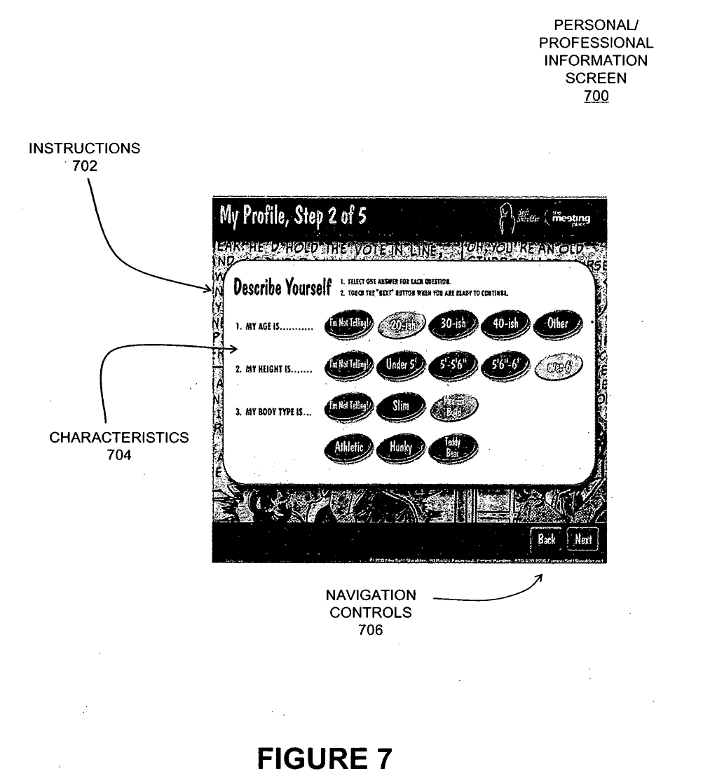

FIG. 7 illustrates a second personal/professional information screen 700 that includes instructions 702, characteristics 704, and navigation controls 706. In the example illustrated, a first user is instructed to describe certain physical characteristics. After entering the data, the user uses the navigation controls 706 to go to the next screen or to go back to the previous screen.

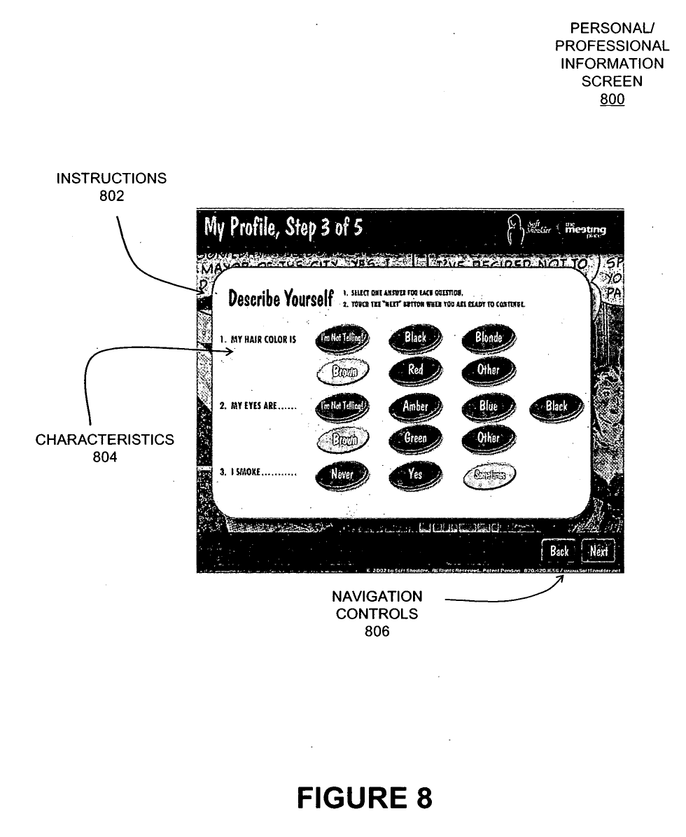

FIG. 8 illustrates a third personal/professional information screen 800 that includes instructions 802, characteristics 804, and navigation controls 806. In the example illustrated, a first user is instructed to describe additional physical characteristics and indicate a smoking preference. After entering the data, the user uses the navigation controls 806 to go to the next screen or to go back to the previous screen.

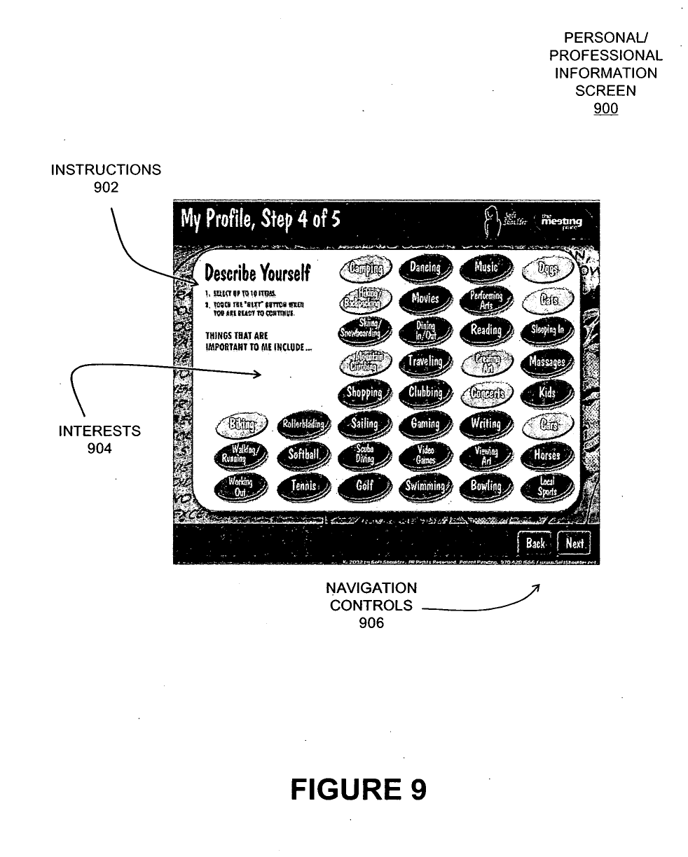

FIG. 9 illustrates a fourth personal/professional information screen 900 that includes instructions 902, interests 904, and navigation controls 906. In the example illustrated, a first user is instructed to describe his interests. The user may select as many interests as desired or the system may be designed to limit the number of interested selected to a desired limit as illustrated in instructions 902. After entering the data, the user uses the navigation controls 906 to go to the next screen or to go back to the previous screen.

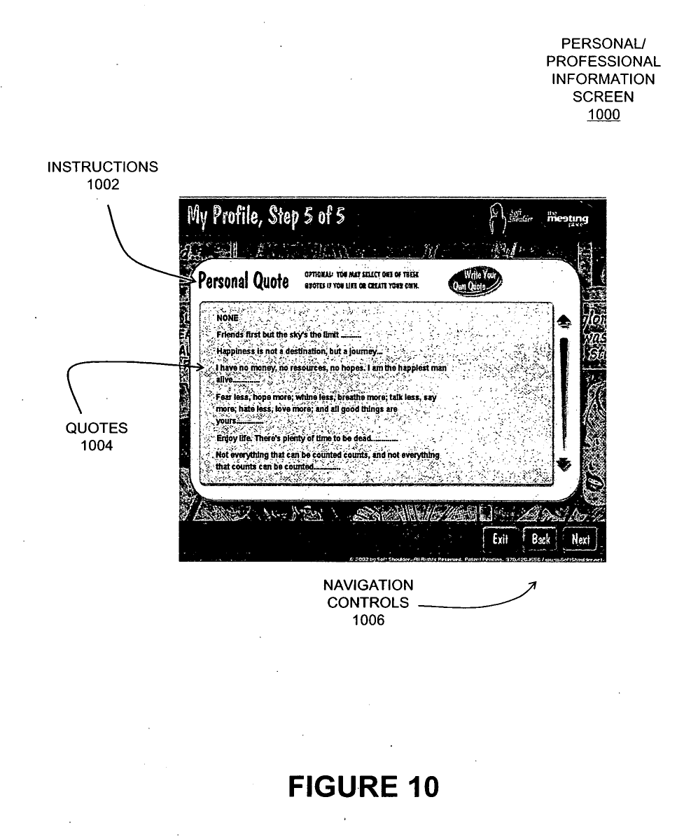

FIG. 10 illustrates a fifth personal/professional information screen 1000 that includes instructions 1002, quotes 1004, and navigation controls 1006. In the example illustrated, a first user is instructed to select from various quotes or to write his own quote as a way to communicate more about his personality. After entering the data, the user uses the navigation controls 1006 to go to the next screen, to go back to the previous screen, or to exit the system.

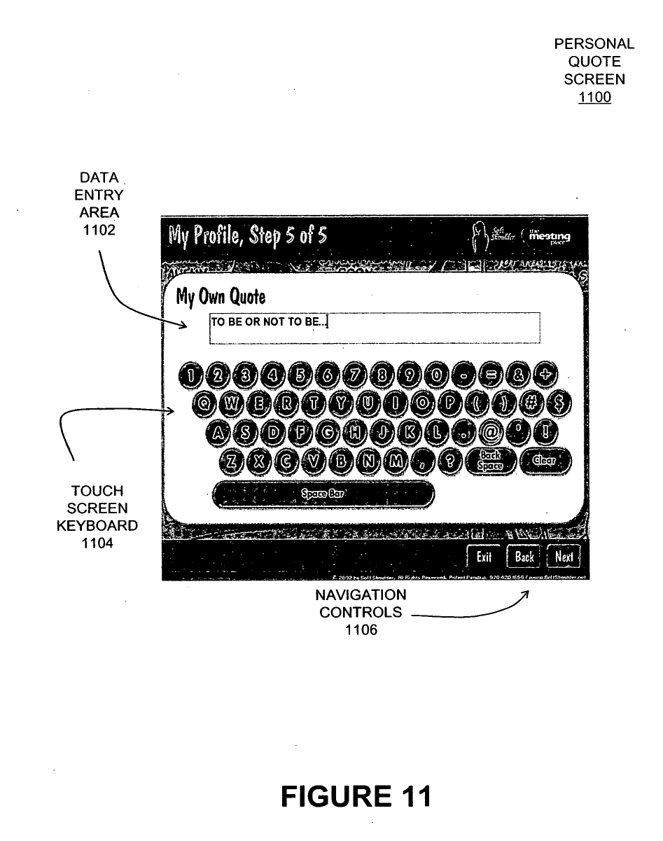

FIG. 11 illustrates a personal quote screen 1100 for writing the users own quote as described in above with respect to FIG. 10. The personal quote screen 1100 includes a data entry area 1102, a touch screen keyboard 1104 and navigational controls 1106. After entering the data, the user uses the navigation controls 1106 to go to the next screen, to go back to the previous screen, or to exit the system.

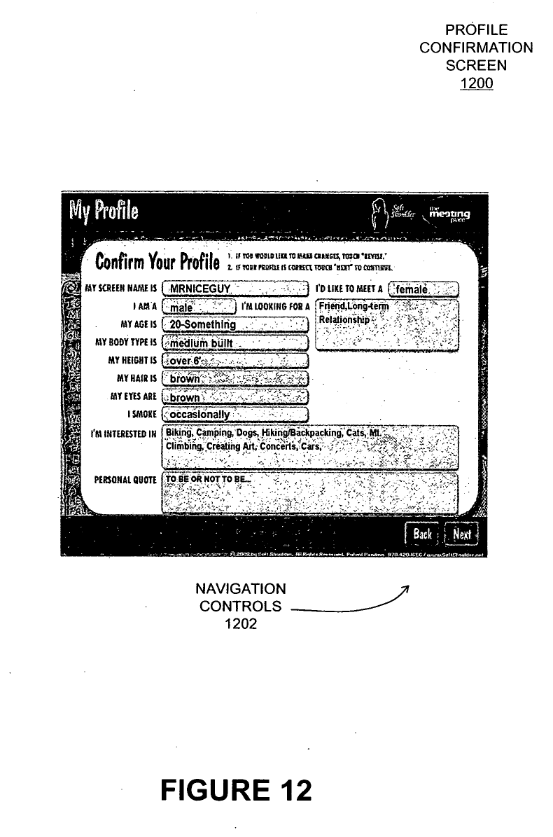

FIG. 12 illustrates a profile confirmation screen 1200 that displays information collected from the previous screens. The profile confirmation screen instructs the user to read the information and to use the navigation controls 1202 to go back to the previous screen, forward to the next screen or revise to modify data directly on the profile confirmation screen 1200.

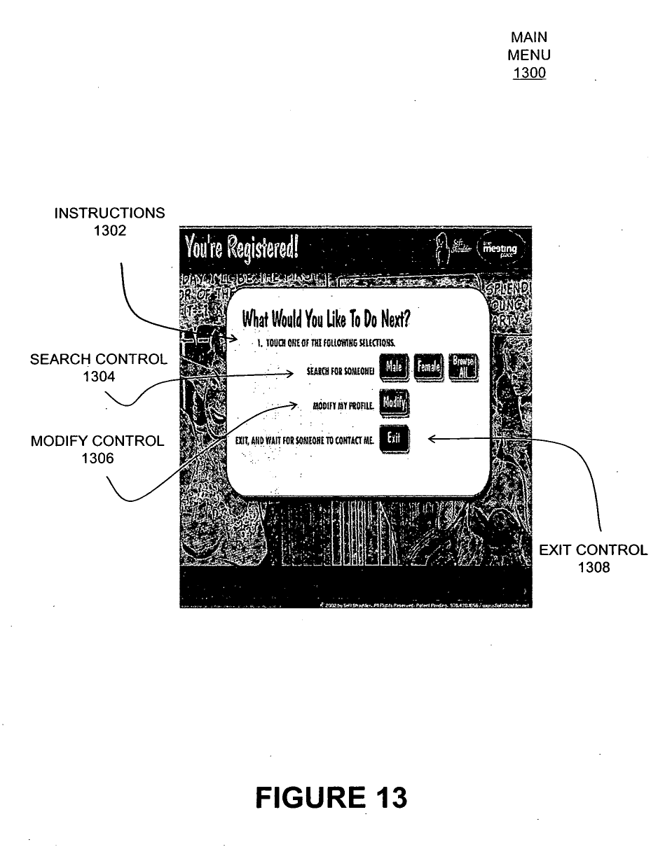

FIG. 13 illustrates a main menu 1300 which has instructions 1302 and navigation controls that allow the user to search for someone using the search control 1304, modify his profile using modify control 1306, or exit the system using exit control 1308.

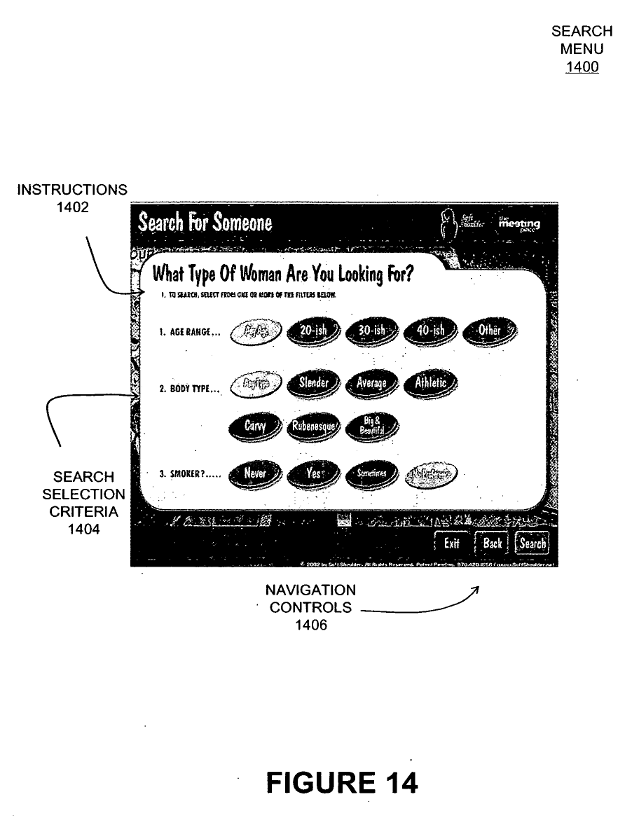

FIG. 14 illustrates a search menu 1400 that includes instructions 1402, search criteria selections 1404, and navigation controls 1406. In the embodiment illustrated, the search selection criteria 1404 allows a first user to select age range, body type, and smoking preference of a second user with whom they desire an introduction. After selecting search criteria, the user uses the navigation controls 1406 to go to the next screen, to go back to the previous screen, or to exit the system.

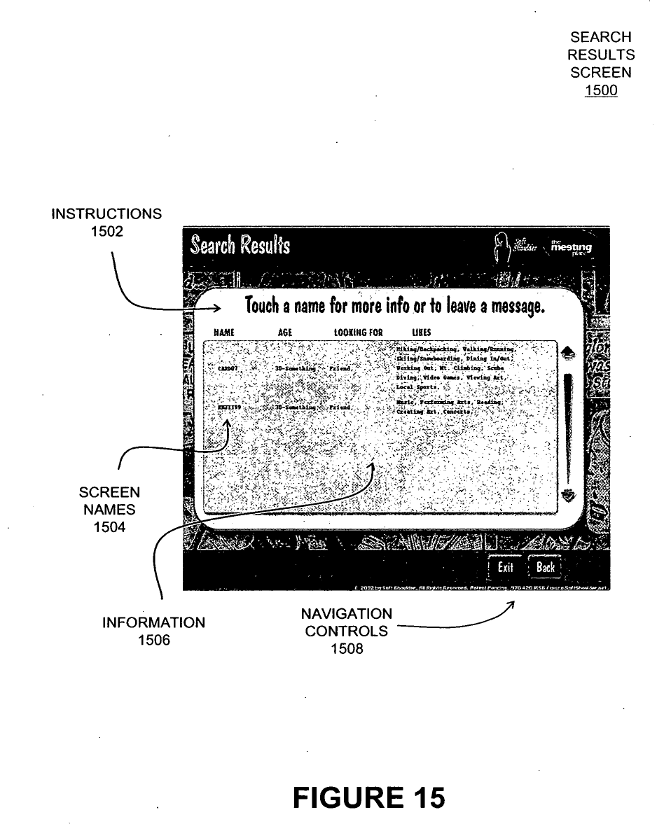

FIG. 15 illustrates a search results screen 1500. The search results screen includes instructions 1502, screen names 1504 and information 1506 of users whose personal/professional information match search criteria entered by a first user. The search results screen includes navigation controls 1508. In the embodiment illustrated, the search results screen instructs the first user to select a name of a user with whom to have an introduction. After selecting a name, the user will be taken to message entry screen described below. The user may alternatively use the navigation controls 1508 to go back to the previous screen or to exit the system.

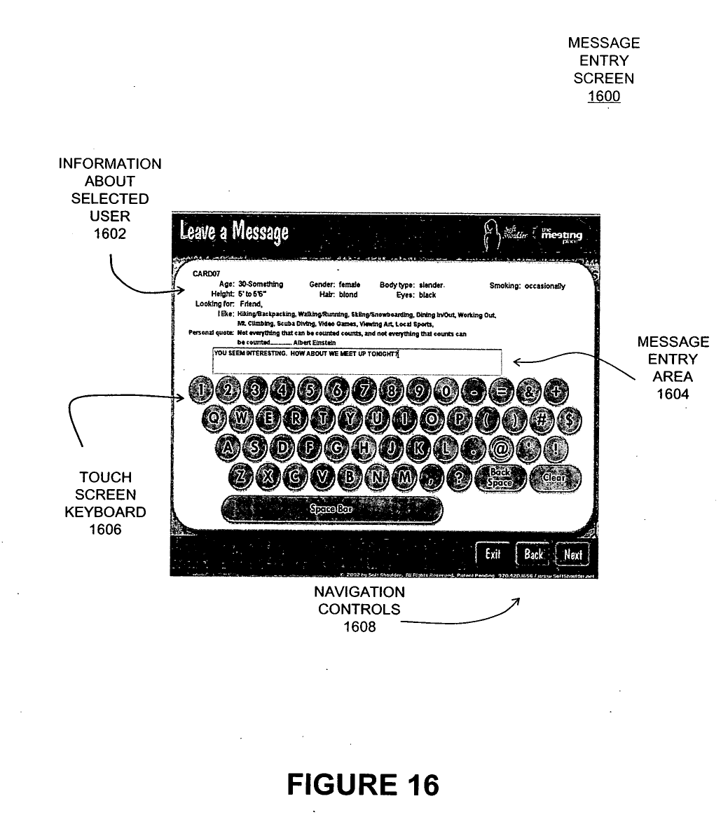

FIG. 16 illustrates a message entry screen 1600 that includes information about a selected user 1602, a message entry area 1604, a touch screen keyboard 1606, and navigation controls 1608. In one embodiment illustrated, a first user enters a message using the touch screen keyboard 1606 indicating that an on-premise introduction is desired. After entering the message, the first user uses the navigation controls to proceed to the next screen if desired. If the user navigates to the next screen, the message entered into the message entry area 1604, is stored with other personal information and available for viewing by the second user.

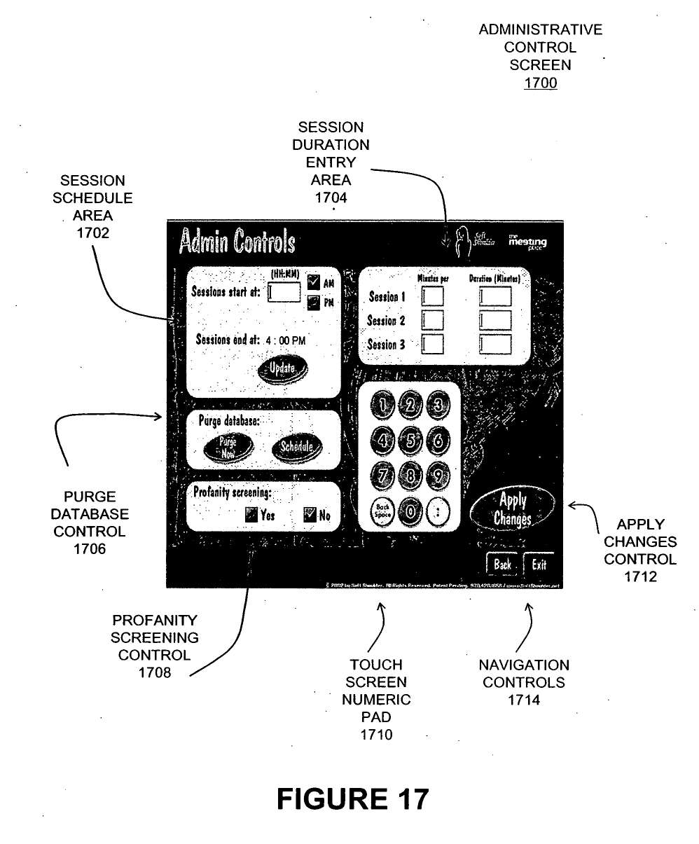

FIG. 17 illustrates an administrative control screen 1700 that includes a session schedule area 1702, a session duration entry area 1704, a purge database control 1706, profanity screening control 1708, a touch screen numeric pad 1710, an apply changes control 1712 and navigation controls 1714. To navigate to the administrative controls screen 1700, an administrator enters authentication data using the client data input/output terminal or using a portable data storage device such as a magnetic stripe card. In one embodiment illustrated, an administrator uses the numeric pad 1710 to enter a session start time and a session end time into the session schedule area 1702. An administrator may further enter a duration into the session duration entry area 1704. For example, in a bar or nightclub application an administrator may schedule the sessions to begin at 7:00 PM with first session having a total duration of 60 minutes and each user having 10 minutes per use. When a user's minutes per use have expired, an application logs the user off and allows a second user to use the system. Later in the evening, a second session having a duration of 60 minutes may be scheduled. An administrator may, if desired, reduce the minutes per use for each user to, for example, five minutes. Limiting the minutes per use enables more users to access the system within a given session duration. The database purge control menu 1706 allows an administrator to purge the screen names and personal/professional information if desired or to schedule a time at which the database will be purged. Alternatively, data for inactivated users may be retained in a database and may be reactivated at any time desired. The profanity screen control 1708 allows an administrator to screen or prohibit profanity from the text messages. If profanity screen control is set to “yes” then words entered into any of the text entry areas are compared with a list of prohibited words and a message is displayed that profanity is not allowed and the user is allowed to re-enter a message. When an administrator has entered data into any of the areas of the administrative control screen, he may select the apply changes control 1712 which saves the state of the selected administrative controls. An administrator may use the navigation controls 1714 to return to the previous menu or to exit the system.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. An on-premise personal introduction facilitation system comprising:
a data processing and storage system that stores and processes personal information from a first user and a second user;
at least one client data input/output device that is electronically connected to said data processing and storage system, and that collects and displays typed personal information and photographic images from a first user and a second user, said client data input/output device located on-premise at a target location;
an authentication mechanism within said data processing and storage system that validates said personal information of said first user and said second user and confirms an authorization status of said first user and said second user to access said data processing and storage system;
database processing software operatively disposed in said data processing and storage system that allows said first user to query a database containing said personal information of said second user and determines information to display which facilitates an on-premise personal introduction between said first user and said second user;
at least one notification device that is electronically connected to said data processing and storage system that delivers messages regarding a desired introduction from said first user to said second user, and from said second user to said first user.

2. The system of claim 1 further comprising:
a portable electronic storage device that stores personal information and photographic images; and
a portable electronic storage interface that reads information from, and writes information to, said portable electronic storage device, said interface being electronically connected to said data processing and storage system.

3. The system of claim 1 further comprising:
at least one timer within said data processing and storage system that is capable of limiting the amount of time the user can spend uninterrupted on the system.

4. The system of claim 1 further comprising:
a software module within said data processing and storage system that is capable of matching attributes of said first user's personal information to a promotional target profile; and
a printer/display electronically connected to said data processing and storage system that prints/displays promotions, discounts for products and services to users whose attributes match said promotional target profile.

5. The system of claim 1 wherein said data input device is chosen from the group consisting of kiosks, personal computers, short text message communication devices, cellular phones, pagers, electronically encoded cards and digital cameras.

6. The system of claim 1 further comprising:
a communication network that connects a plurality of on-premise personal introduction facilitation systems.

7. The system of claim 6 wherein said communication network is a wireless network.

8. The system of claim 6 wherein said communication network is a virtual private network that uses the Internet.

9. A method of facilitating timely on-premise personal introductions comprising:
providing an on-premise personal introduction facilitation system that includes a data processing and storage system which is electronically connected to at least one client data input/output device that captures and displays personal information and photographic images, said data processing and storage system being further electronically connected to at least one notification device.
registering a first user and a second user by assigning an electronically encoded identifier;
collecting and editing personal information and photographic images of a first user and a second user using said client data input/output device;
storing said personal information and photographic images of said first user and said second user in a database within said data processing and storage system;
authenticating credentials of said first user and said second user using said data processing and storage system;
enabling said first user to search said database and display personal information and photographic images of said second user;
notifying said second user, using said notification device, that said first user desires a personal introduction to said second user;
displaying to said second user, through a client data input/output device, said personal information and photographic images of said first person; and
notifying said first user of said second user's interest in a personal introduction.

10. A method of facilitating timely on-premise personal introductions comprising:
providing an on-premise personal introduction facilitation system that includes a data processing and storage system which is electronically connected to at least one client data input/output device that captures and displays personal information and photographic images, said data processing and storage system being further electronically connected to at least one notification device;
retrieving, from a portable electronic storage device, previously stored personal information and photographic images for a first user and a second user;
editing said personal information and photographic images using said client data input/output device as desired;
authenticating credentials of said first user and said second user using said data processing and storage system;
enabling said first user to search said database and display personal information and photographic images of said second user;
notifying said second user, using said notification device, that said first user desires a personal introduction to said second user;
displaying to said second user, through a client data input/output device, said personal information and photographic images of said first person; and
notifying said first user of said second user's interest in a personal introduction.
